(19) United States
(12) Patent Application Publication
(10) Pub. No.: US 2013/0000297 A1
(43) Pub. Date: Jan. 3, 2013

(54) EMISSIONS REDUCTION SYSTEM

(75) Inventors: Keith E. Moravec, Downers Grove, IL (US); Ajay Patel, Joliet, IL (US); James W. Heilenbach, Riverside, IL (US)

(73) Assignee: Electro-Motive Diesel, Inc.

(21) Appl. No.: 13/485,182

(22) Filed: May 31, 2012

Related U.S. Application Data
(60) Provisional application No. 61/502,730, filed on Jun. 29, 2011.

(51) Int. Cl. F01N 3/035; F02B 37/00; F02B 37/16

(52) U.S. Cl. 60/600; 60/311; 60/297; 60/274

(57) ABSTRACT

In one aspect of the present disclosure, an exhaust emission reduction system is provided for an internal combustion engine. The engine receives an air stream for combustion with fuel in the engine and also generates an engine exhaust steam. The system includes a filter assembly having one or more exhaust emission reduction elements configured to process the exhaust stream, a performance of at least one of the one or more exhaust emission reduction elements being temperature dependent. The system also includes an apparatus for changing the temperature of the exhaust stream incident on the filter assembly. The system further includes a controller operatively connected to the apparatus, and adapted to regulate the temperature of the exhaust stream incident on the filter assembly based on the temperature of the exhaust stream.

Applicant claims priority to Provisional Application No. 61/502,730, filed Jun. 29, 2011, the entire contents of which are hereby incorporated by reference.

### TECHNICAL FIELD

The present disclosure generally relates to exhaust emission reduction systems for internal combustion engines and, more specifically, to an emission reduction system that may be integrated in the exhaust manifold.

### BACKGROUND

FIGS. 1A and 1B illustrate a conventional turbocharged two-stroke locomotive diesel engine system 101 having a conventional air/exhaust system 103 as shown in FIG. 1C. Referring concurrently to FIGS. 1A-1C, the locomotive diesel engine system 101 generally comprises a turbocharger 100 having a compressor 102 and a turbine 104, which provides compressed air to an engine 106 having an airbox 108, power assemblies 110, an exhaust manifold 112, and a crankcase 114. In a typical locomotive diesel engine system 101, the turbocharger 100 increases the power density of the engine 106 by compressing and increasing the amount of air transferred to the engine 106 and thus the amount of fuel that can be combusted.

More specifically, the turbocharger 100 draws air from the atmosphere 116, which is filtered using a conventional air filter 118. The filtered air is compressed by a compressor 102. The compressor 102 is powered by a turbine 104, as will be discussed in further detail below. A larger portion of the compressed air (or charge air) is transferred to an aftercooler (or otherwise referred to as a heat exchanger, charge air cooler, or intercooler) 120 where the charge air is cooled to a select temperature. Another smaller portion of the compressed air is transferred to a crankcase ventilation oil separator 122, which evacuates the crankcase 114 in the engine; entrains crankcase gas; and filters entrained crankcase oil before releasing the mixture of crankcase gas and compressed air into the atmosphere 116.

The two-stroke locomotive diesel engine depicted in FIGS. 1A and 1B has a power assembly 110 with two cylinder banks 127a, 127b, each having a plurality of cylinders 125 closed by cylinder heads 126 having respective fuel injectors 121. Pistons 128, reciprocable within the cylinders 125, define variable volume combustion chambers between the pistons 128 and cylinder heads 126.

The cooled charge air from the aftercooler 120 enters the engine power assemblies 110 via an airbox 108. The decrease in charge air intake temperature provides a denser intake charge to the engine, which reduces NOₓ emissions while improving fuel economy. The airbox 108 is a single enclosure, which distributes the cooled air to the plurality of cylinders 125 through intake ports 135. Each of the cylinders 125 is closed by a cylinder head 126. Fuel injectors 121 in the cylinder heads 126 introduce fuel into each of the cylinders 125, where the fuel is mixed and combusted with the cooled charge air. Each cylinder 125 includes a piston 128 which transfers the resultant force from combustion to the crankshaft 130 via a connecting rod 132. The piston 128 includes a piston bowl, which facilitates mixture of fuel and trapped gas (including cooled charge air) necessary for combustion. The cylinder heads 126 include exhaust ports controlled by exhaust valves 134 mounted in the cylinder heads 126, which regulate the amount of exhaust gases expelled from the cylinders 125 after combustion.

Exhaust gases from the combustion cycle exit the engine 106 via an exhaust manifold 112. The exhaust gas flow from the engine 106 is used to power the turbine 104 and thereby power the compressor 102 of the turbocharger 100. After powering the turbine 104, the exhaust gases are released into the atmosphere 116 via an exhaust stack or silencer 124.

The combustion cycle of a two-stroke diesel engine includes, what is referred to as, scavenging and mixing processes. During the scavenging and mixing processes, a positive pressure gradient is maintained from the intake port of the airbox 108 to the exhaust manifold 112 such that the cooled charge air from the airbox 108 charges the cylinders and scavenges most of the combusted gas from the previous combustion cycle. More specifically, during the scavenging process in the power assembly 110, the cooled charge air enters one end of a cylinder controlled by an associated piston and intake ports. The cooled charge air mixes with a small amount of combusted gas remaining from the previous cycle. At the same time, the larger amount of combusted gas exits the other end of the cylinder via four exhaust valves 134 and enters the exhaust manifold 112 as exhaust gas. The control of these scavenging and mixing processes is instrumental in emissions reduction, as well as in achieving desired levels of fuel economy, particularly in two-stroke cycle engines.

The exhaust gases released into the atmosphere by such a two-stroke diesel engine include particulates, nitrogen oxides (NOₓ) and other pollutants. Legislation incorporating stringent emission standards has been passed to reduce the amount of pollutants that may be released into the atmosphere. These standards include what is referred in the industry as the Environmental Protection Agency's (EPA) Tier II (40 CFR 92), Tier III (40 CFR 1033), and Tier IV (40 CFR 1033) emission requirements, as well as the European Commission (EURO) Tier Mb emission requirements.

Traditional systems have been implemented which reduce these pollutants, but at the expense of fuel efficiency. Accordingly, there is a need to provide an emission reduction system that reduces the amount of pollutants (e.g., particulates, nitrogen oxides (NOₓ) and carbon monoxide (CO)) released by the diesel engine while achieving desired fuel efficiency. The various embodiments of the disclosed emission reduction system may meet or exceed the above-mentioned standards.

Some engine system applications must also be able to operate within specific length, width, and height constraints. For example, the length of a locomotive must be below that which is necessary for it to negotiate track curvatures or a minimum track radius. In another example, the width and height of the locomotive must be below that which is necessary for it to clear tunnels or overhead obstructions. Locomotives have been designed to utilize all space available within these size constraints. Therefore, locomotives have limited space available for adding new engine system components thereon. Accordingly, there is a need to provide an emissions reduction system that may be integrated within the size and operational environment constraints of the intended engine system application.

### SUMMARY

In one aspect of the present disclosure, an exhaust emission reduction system is provided for an internal combustion engine. The engine receives an air stream for combustion with fuel in the engine and also generates an engine exhaust steam. The system includes a filter assembly having one or more exhaust emission reduction elements configured to process the exhaust stream, a performance of at least one of the one or more exhaust emission reduction elements being temperature dependent. The system also includes an apparatus for changing the temperature of the exhaust stream incident on the filter assembly. The system further includes a controller operatively connected to the apparatus, and adapted to regulate the temperature of the exhaust stream incident on the filter assembly based on the temperature of the exhaust stream.

In another aspect of the present disclosure, a method is disclosed for reducing exhaust emissions from an internal combustion engine that receives an air stream for combustion with fuel in the engine and generates an engine exhaust stream. The engine includes a filter assembly having one or more exhaust emission reduction elements for processing the exhaust stream, a performance of at least one of the one or more exhaust emission reduction elements being temperature dependant. The method includes monitoring the temperature of the exhaust stream incident on the filter assembly. The method further includes regulating the temperature of the exhaust stream upstream of the filter assembly based on the monitored temperature using an exhaust gas temperature-changing apparatus and a controller to control the apparatus.

### BRIEF DESCRIPTION OF THE DRAWINGS

FIG. 1A is perspective view of a conventional turbocharged two-stroke locomotive diesel engine.

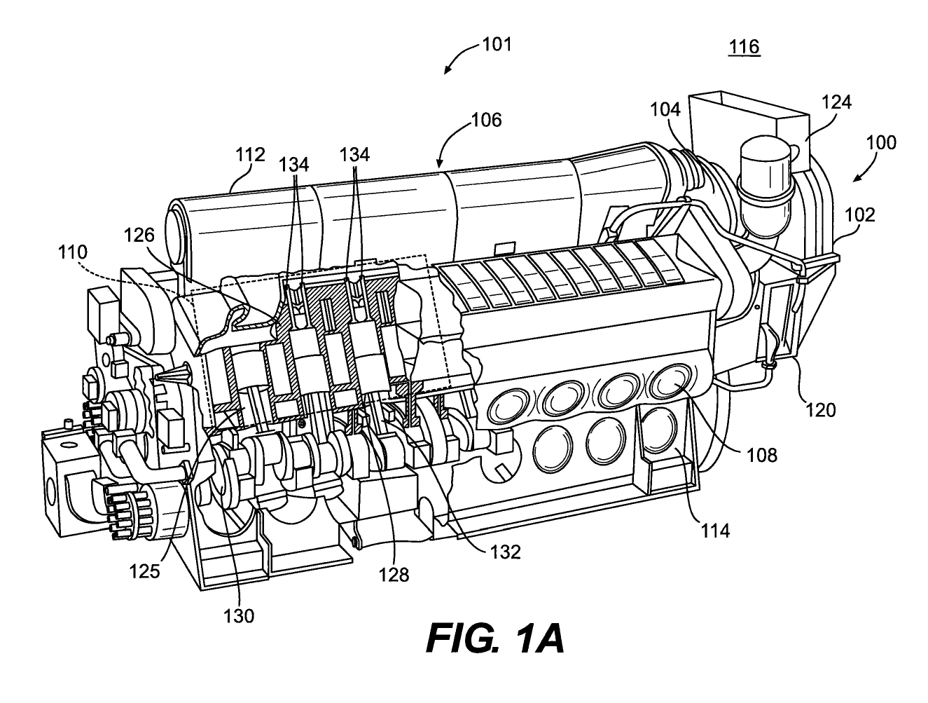

FIG. 1B is a partial cross-sectional view of the two-stroke diesel engine of FIG. 1A.

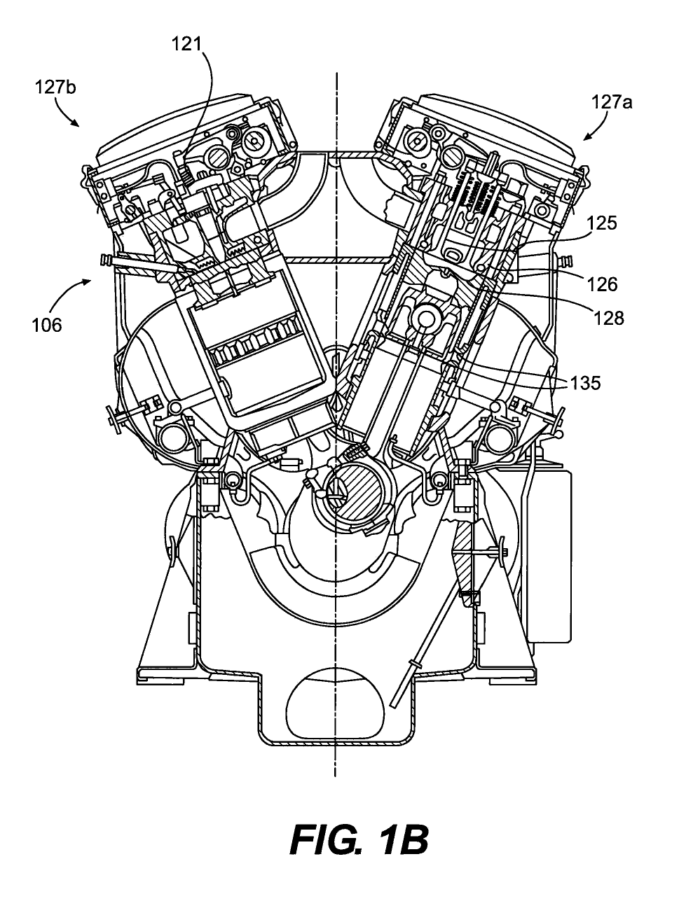

FIG. 1C is a flow diagram of the conventional air/exhaust system for the two-stroke diesel engine of FIG. 1A.

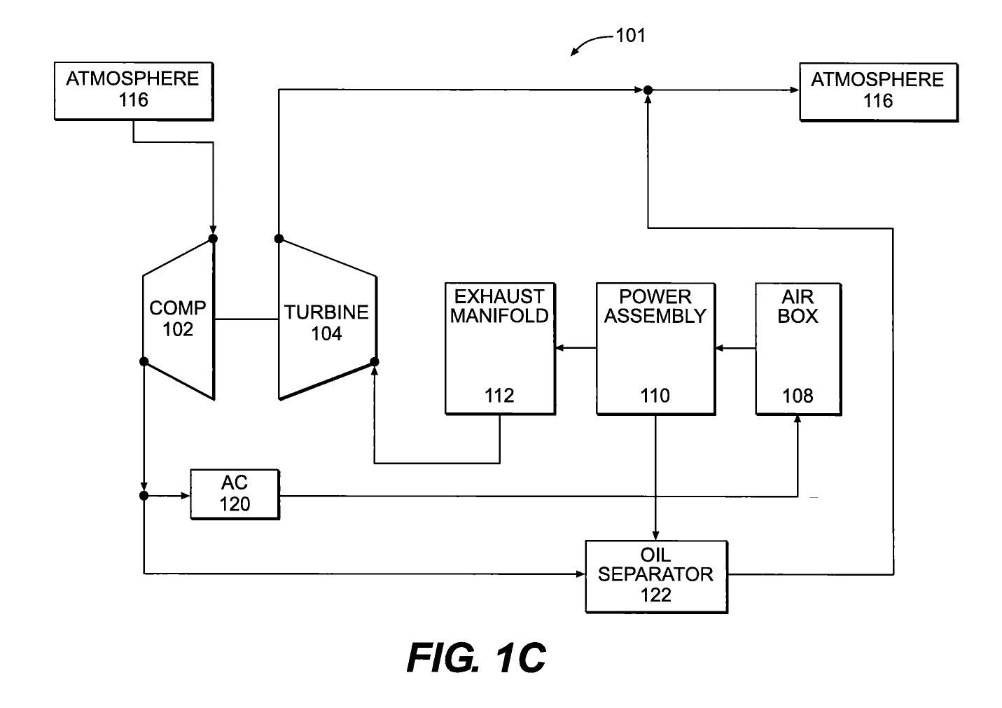

FIG. 2 is a system flow diagram of a turbocharged locomotive two-stroke diesel engine of the general type shown in FIGS. 1A-1C but having an engine emission reduction system presently disclosed herein.

FIG. 3 is a system diagram of other embodiments of a two-stroke diesel engine having the disclosed engine exhaust emission reduction system, including an optional EGR system and/or an optional exhaust after-treatment system.

FIG. 4 is a flow chart of an engine exhaust emission reduction method in accordance with the present disclosure.

### DETAILED DESCRIPTION

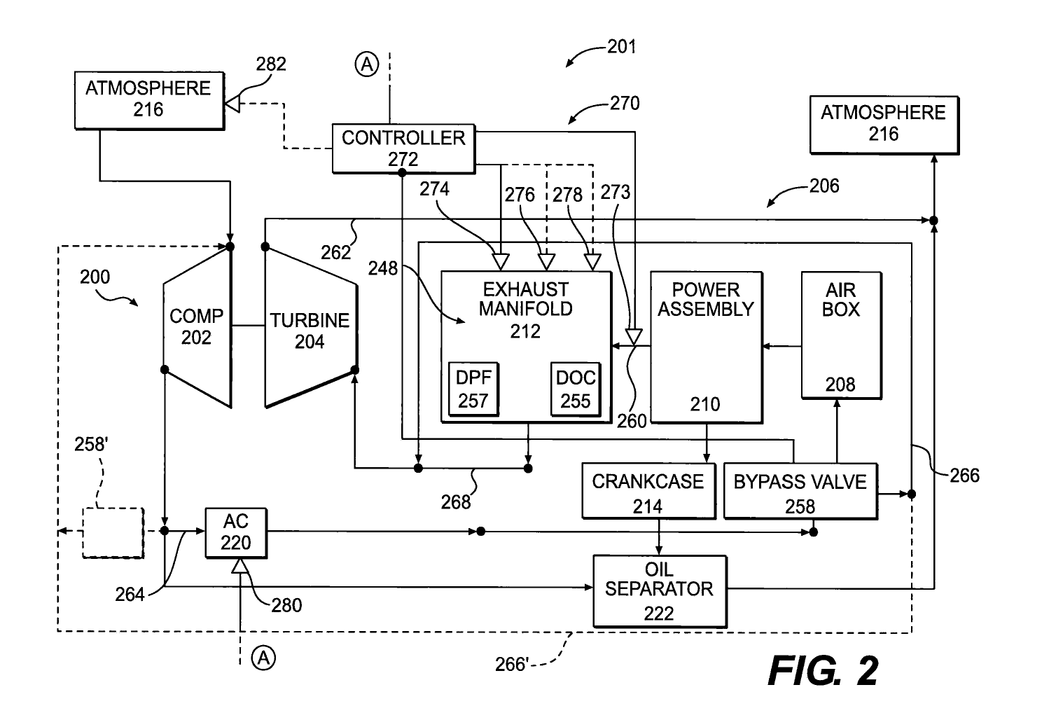

The present disclosure is directed to an emission reduction system for an internal combustion engine, for reducing pollutants, namely particulate matter, hydrocarbons and/or carbon monoxide and NOₓ emissions released from the engine. As illustrated schematically in FIG. 2, the engine system 201 includes two-stroke locomotive diesel engine 206 that is adapted to have reduced NOₓ, particulate, hydrocarbon, and/or carbon monoxide emissions in accordance with the present disclosure. Specifically, the scavenging and mixing processes may be optimized in accordance with the present disclosure to reduce NOₓ and particulate emissions to a desired level. In order to reduce particulate, hydrocarbon and/or carbon monoxide emissions from the exhaust, the present engine system includes an exhaust emissions reduction system generally designated by the numeral 270.

For example, the exhaust emissions reduction system 270 may include a filter assembly 248, as illustrated in FIG. 2. In this embodiment, the filtration system 248 is integrated into engine exhaust manifold 212 and includes a diesel oxidation catalyst (DOC) 255 and a diesel particulate filter (DPF) 257 to filter the exhaust stream 260 from the cylinders in power assembly 210. In one embodiment, the diesel particulate filter (DPF) 257 may be in the form of a catalyzed partial flow diesel particulate filter. The DOC 255 uses an oxidation process to reduce the particulate matter (PM), hydrocarbons and/or carbon monoxide emissions in the exhaust gases. The partial DPF 257 includes a filter to reduce particulate matter such as soot from the exhaust gases. The DOC/DPF 255/257 arrangement of filter assembly 248 may be adapted to passively regenerate and oxidize soot in the exhaust gas stream 260. Although a DOC 255 and DPF 257 are shown, other comparable filters may be used. For example, a catalyzed diesel particulate filter may be used such that a diesel oxidation catalyst is not required.

At the exhaust manifold 212, exhaust gas is highly pressurized and exhaust gas temperature is naturally high due to its proximate location to the combustion events. Therefore, regeneration of the DOC/DPF arrangement 255/257 may be activated without, or with minimized, heating. Specifically, because the temperature of exhaust gas in the exhaust manifold 212 is higher, as compared to the temperature of the exhaust gas stream 262 downstream of the turbine 204, the DOC 255 requires less heating for regeneration to occur.

Nevertheless, the filtration system 248 may be further monitored by a system controller 272, which monitors the temperature of exhaust gas upstream of filter assembly 248 using sensor 273 and maintains the cleanliness of the DOC 255 and DPF 257. In one embodiment, the system controller 272 also determines and monitors the pressure differential across the DOC/DPF 255/257 arrangement using pressure sensors 274 to detect soot buildup. As discussed above, the DOC/DPF 255/257 arrangement may be adapted to regenerate and oxidize soot within the DPF 257. However, if the DPF 257 is not in the form of a catalyzed partial flow diesel particulate filter, the DPF 257 may accumulate ash and soot, which must be removed in order to maintain the DPF 257 efficiency. As ash and soot accumulate, the pressure differential across the DOC/DPF 255/257 arrangement increases. Accordingly, the control system monitors and determines whether the DOC/DPF 255/257 arrangement has reached a select pressure differential at which the DPF 257 requires cleaning or replacement. In response thereto, the system controller 272 may signal an indication that the DPF 257 requires cleaning or replacement. As discussed above, if the DPF 257 is in the form of a catalyzed partial flow diesel particulate filter, the DPF would not require cleaning or replacement as such a filter is designed not to accumulate ash and soot.

The system controller 272 may be coupled to an apparatus for changing the temperature of the exhaust stream incident on filter assembly 248. Such an apparatus may include a DOC/DPF doser 276 (e.g., a hydrocarbon injector), which adds fuel onto the catalyst for the DOC/DPF 255/257 arrangement for regeneration of the filter if the exhaust temperature at the exhaust manifold is not high enough to promote passive regeneration of the filter. Specifically, the fuel reacts with oxygen in the presence of the catalyst, which increases the temperature of the exhaust gas to promote oxidation of soot on the filter. In yet another embodiment, the control system may be coupled to an optional burner or other heating element 278 for controlling the temperature of the exhaust gas in the exhaust manifold 212 to control oxidation of soot on the filter.

As depicted in FIG. 2, the system controller 272 may alternatively or further be adapted to monitor the charge air temperature in air stream 264 upstream of an aftercooler 220 and adaptively control cooling and/or heating of the charge air by the aftercooler 220, to indirectly affect the temperature of the exhaust stream. Specifically, using sensor 280, the system controller 272 may be configured to control the temperature of the charge air at the aftercooler 220 based on locomotive operating conditions, for the following reasons.

Because the charge air entering the aftercooler 220 from compressor 202 of the turbocharger 200 is pressurized, it is desirable to cool it for engine performance and efficiency. The aftercooler 220 cools the fresh charge air from the turbocharger 200 to decrease the overall charge air intake temperature of the engine 206, thereby providing a denser intake charge air to the engine 206. Yet, as discussed above, the exhaust manifold 212 must be heated to a select temperature to promote regeneration of the DPF 257. Therefore, the system controller 272 may be adapted to control the aftercooler 220 to either heat or cool the charge air to promote regeneration of the DPF 257 while maintaining engine performance and efficiency.

Additionally, the system controller 272 may be adapted to monitor the ambient temperature of atmosphere 216. Based on the measured temperature, the control system may be further adapted to control an optional thermal device 282 for adjusting the temperature of the air entering the turbocharger, again to regulate the exhaust stream temperature and to facilitate regeneration of the DOC/DPF 255/257 arrangement in filter assembly 248.

As further depicted in FIG. 2, the engine system 201 may further or alternatively include a bypass valve 258 upstream of an airbox 208. Specifically, the bypass valve 258 may be used to control a select amount of cooled charge air to bypass the airbox 208 and, in turn, more directly control the temperature in the exhaust manifold 212 as monitored by sensor 273. Generally, the exhaust manifold 212 temperature decreases as more cooled charge air is supplied to the airbox 208 and increases with less charge air. Accordingly, the system controller 272 may be operatively coupled to the bypass valve 258 to assist in the control of temperature in the exhaust manifold 212. For example, diverting cooled charge air from entering the airbox 208 results in higher temperatures in the airbox and improved performance of the DOC/DPF 255/257 arrangement.

In a particular locomotive application, at a locomotive throttle notch 2, bypassing about 20% of the charge air from entering the engine 206 would cause a 60° F. increase in temperature in the exhaust manifold 212. Therefore, at throttle notch 2, the control system may be adapted to actuate the bypass valve 258 to increase the temperature of the exhaust gas in the exhaust manifold 212. Moreover, the bypass valve 258 may be used to further control the temperature in the exhaust manifold in order to effectively enhance the performance of an optional exhaust gas recirculation system and/or an optional exhaust after-treatment system, as will be discussed subsequently.

As depicted in FIG. 2, the select amount of diverted charge air can be channeled along path 266 and introduced to the exhaust gas stream 268 upstream of turbine 204 to recover pressure-volume energy. However, in yet another variation, the bypass valve is situated such that the select amount of charge air downstream of the aftercooler 220 is redirected along (dotted) path 266′ back to the compressor 202 of the turbocharger. Or, alternatively, the select amount of charge air may be taken from a point upstream of the aftercooler 220 and returned to the entrance of compressor 202. This latter embodiment would require the bypass valve to be repositioned as depicted in FIG. 2 as (dotted) bypass valve 258′. In addition to reducing engine exhaust emissions, an added advantage of these system variations is that the temperature of exhaust gas increases downstream of the turbocharger. Accordingly, any post-turbocharger emission reduction apparatus, such as e.g. after-treatment systems, may benefit from such temperature increase. Specifically, in these latter embodiments, the select amount of cooled charge air is not mixed with the exhaust gas exiting the exhaust manifold in contrast to the previous embodiments.

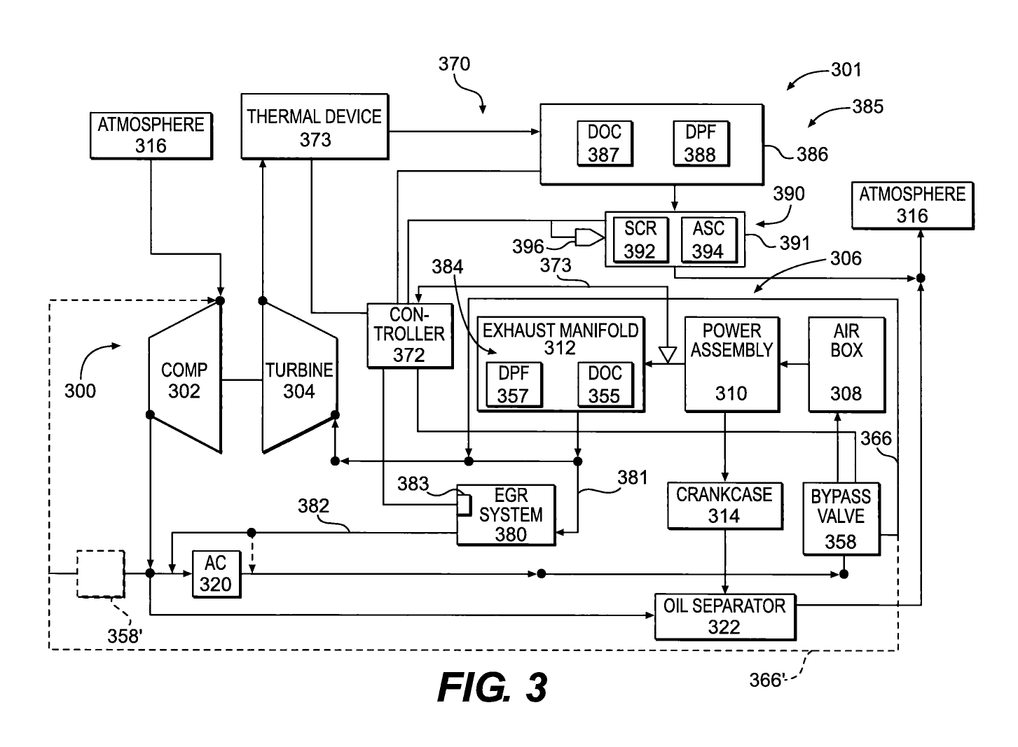

Additionally, and as depicted in FIG. 3, the present exhaust emission reduction systems may include an optional exhaust gas recirculation (EGR) system and/or an optional after-treatment system in order to further reduce emissions from the engine. When not specifically identified, elements having a 300-series number shown in FIG. 3 are to be understood as having a similar configuration and function as the elements of FIG. 2 with a 200-series number. That is, e.g., alternate diverted charge air paths 366 and 366′ in FIG. 3 correspond to the alternate diverted charge air paths 266 and 266′ in FIG. 2. However, it should also be understood that controller 372 of system 301, which may be a suitable computer device with a processing unit, memory, and stored control algorithms and programs, would be configured similar to controller 272 of system 201, but with the added capability of executing programs/algorithms relating to the integrated EGR and/or after-treatment systems and apparatus.

For example, as part of overall engine emission reduction system 370 of engine system 301, an optional EGR system 380 is shown in FIG. 3, in which a select percentage of the exhaust gases is recirculated via path 381, 382 and mixed with the intake compressed air either before or after air cooler 320, in order to selectively reduce pollutant emissions (including NOₓ) while achieving desired fuel efficiency. The percentage of exhaust gases to be recirculated is also dependent on the amount of exhaust gas flow needed for powering the compressor 302 of the turbocharger 300. It is desired that enough exhaust gas powers the turbine 304 of the turbocharger 300 such that an optimal amount of fresh air is transferred to the engine 306 for combustion purposes.

In locomotive diesel engine applications, it may be desired that less than about 35% of the total gas (including compressed fresh air from the turbocharger and mixed recirculated exhaust gas) delivered to the airbox 308 be recirculated. This arrangement provides for pollutant emissions (including NOₓ) to be reduced, while achieving desired fuel efficiency. In the optional EGR system 380 depicted in FIG. 3, a flow regulating device 383 under the control of controller 372 may be provided for regulating the amount of exhaust gases to be recirculated. The flow regulating device may be a valve or, alternatively, a positive flow device (e.g. a pump) that provides for the necessary pressure increase to overcome the pressure loss within the internal EGR loop and to overcome the adverse pressure gradient between the exhaust manifold 312 and the introduction location of the recirculated exhaust gas.

In order to comply with the most stringent emissions standards, the present system may alternatively or additionally include an exhaust after-treatment system for further reducing particulate matter (PM), hydrocarbons and/or carbon monoxide emissions from the engine system. Specifically, the engine system may also be adapted to have reduced NOₓ emissions. For example, an optional exhaust after-treatment system 385 is shown in FIG. 3, for further reducing emissions from the exhaust. The optional exhaust after-treatment system 385 may include an after-treatment filter assembly 386 to filter other emissions including particulate matter from the exhaust. More specifically, the optional exhaust after-treatment system may include a diesel oxidation catalyst (DOC) 387 and a diesel particulate filter (DPF) 388. In one embodiment, the diesel particulate filter may be in the form of a catalyzed partial flow diesel particulate filter. The DOC 387 uses an oxidation process to reduce the particulate matter (PM), hydrocarbons and/or carbon monoxide emissions in the exhaust gases. The partial DPF (not shown) includes a filter to reduce PM and/or soot from the exhaust gases. The DOC/DPF arrangement may be adapted to passively regenerate and oxidize soot at the DPF 388. Although a DOC 387 and DPF 388 are shown, other comparable filters may be used. For example, a catalyzed diesel particulate filter may be used such that a diesel oxidation catalyst is not required. Moreover, the DOC/DPF arrangement may be coupled to an optional thermal device such as burner 373 to control the temperature of the exhaust gas from the turbocharger and facilitate passive regeneration of the DPF in exhaust after-treatment system 385.

Additionally, the optional exhaust after-treatment system 385 of FIG. 3 may further include a NOₓ reduction system, which may be controlled by controller 372. In one example, and with continued reference to FIG. 3, a NOₓ reduction system 390 includes a selective catalyst assembly 391, catalytic reduction (SCR) catalyst 392, and an ammonia slip catalyst (ASC) 394 adapted to lower NOₓ emissions of the engine 306. The SCR 392 and ASC 394 may be further coupled to an SCR doser 396, for dosing an SCR reductant fluid or SCR reagent (e.g., urea-based, diesel exhaust fluid (DEF)). Upon injection of the SCR reductant fluid or SCR reagent, the NOₓ from the exhaust reacts with the reductant fluid over the catalyst in the SCR and ASC to form nitrogen and water. Although a urea-based SCR 392 is shown, other SCRs known in the art may also be used (e.g., hydrocarbon based SCRs, solid SCRs, De-NOₓ systems, etc.). In yet another embodiment, the system may be adapted to lower NOₓ emissions prior to lowering the particulate matter (PM), hydrocarbons and/or carbon monoxide emissions. In such an arrangement, the SCR system may be located upstream of the filter assembly 386.

### INDUSTRIAL APPLICABILITY

The disclosed emissions reduction system enhances the scavenging and mixing processes of two-stroke diesel engines to further reduce NOₓ emissions, while achieving desired fuel economy. The disclosed emissions reduction system may be coupled optionally with exhaust after-treatment systems and components and/or exhaust gas recirculation (“EGR”) systems and components to further reduce emissions. In one embodiment the exhaust emission reduction system includes emission reduction elements constructed to fit within the limited size constraints of a locomotive exhaust manifold and designed for ease of maintainability.

The present system may further be enhanced by adapting the various engine parameters, the EGR system parameters, and/or the exhaust after-treatment system parameters. For example, as discussed above, emissions reduction and achievement of desired fuel efficiency may be accomplished by maintaining or enhancing the scavenging and mixing processes in a uniflow two-stroke diesel engine (e.g., by adjusting the intake port timing, intake port design, exhaust valve design, exhaust valve timing, EGR system design, engine component design and/or turbocharger design).

The various embodiments incorporating the exhaust emissions reduction systems of the present disclosure may be applied to locomotive two-stroke diesel engines having various numbers of cylinders (e.g., 8 cylinders, 12 cylinders, 16 cylinders, 18 cylinders, 20 cylinders, etc.). The various embodiments may further be applied to two-stroke scavenged diesel engine applications other than for locomotive applications (e.g., marine and stationary power supply applications). And further, the various embodiments may be applied to gasoline powered engine systems including both two-stroke and four-stroke engine configurations.

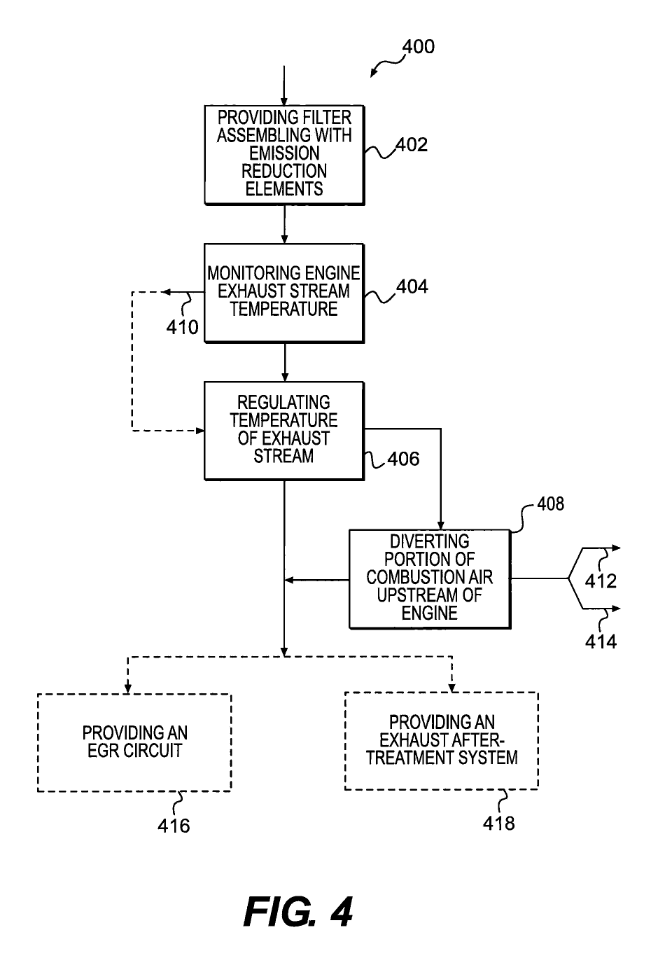

Moreover, the method of engine exhaust reduction method disclosed herein, and illustrated in its broadest context in FIG. 4 has a similar usefulness. Specifically, FIG. 4 illustrates an engine exhaust emission reduction method 400 for an engine receiving a combustion air stream and generating an exhaust stream. Method 400 first includes the step 402 of providing a filter assembly having one or more exhaust emission reduction elements for processing an engine exhaust stream closely adjacent the engine, and before the engine turbine component, if the engine is turbocharged. As discussed previously, the performance of at least one of the emission reduction elements is temperature dependent.

The method 400 next includes the step 404 of monitoring the temperature of the exhaust stream incident on the filter assembly with the emission reduction elements. This method element is intended to provide temperature data 410 of the exhaust stream incident on the filter assembly.

Method 400 next includes the step 406 of regulating the temperature of the exhaust stream upstream of the filter assembly using a system controller to control a device for changing the temperature of the exhaust stream incident on the filter assembly based on the monitored temperature 410 from element 404. Step 406 may specifically include the step 408 of diverting a portion of the combustion air upstream of the engine using a bypass valve. This diverting step may include diverting the air stream portion along path 412 to a location downstream of the filter assembly, and/or along a path 414 to a location in the air stream that is upstream of the bypass valve.

Method 400 may further include the optional element 416 of providing an EGR circuit with a flow control device, and using the system controller to control the flow control device.

Method 400 may still further include the optional element 418 of providing an exhaust after-treatment assembly with a temperature dependent filter component, and using the system controller to control the temperature of the exhaust stream incident on the filter component, using a heating device. While depicted in separate logic paths in FIG. 4, both method elements 416 and 418 may be performed concurrently in method 400.

The disclosed emissions reduction systems depicted may be sized and shaped to fit within limited length, width, and height constraints of a locomotive application. The optional EGR system and optional exhaust after-treatment system are installed within the same general framework of traditional modern diesel engine locomotives. For example, the optional exhaust after-treatment system may be generally located in the limited space available above the locomotive engine within the locomotive car body frame.

While the presently disclosed exhaust emission reduction system and method have been described with reference to certain illustrative aspects, it will be understood that this description shall not be construed in a limiting sense. Rather, various changes and modifications can be made to the illustrative embodiments without departing from the true spirit, central characteristics and scope of the disclosure, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

What is claimed is:

1. An exhaust emission reduction system for an internal combustion engine, the engine receiving an air stream for combustion with fuel in the engine and generating an engine exhaust stream, the system comprising:
a filter assembly having one or more exhaust emission reduction elements configured to process the engine exhaust stream, a performance of at least one of the one or more exhaust emission reduction elements being temperature dependent;
an apparatus configured to change a temperature of the engine exhaust stream incident on the filter assembly; and
a controller operatively connected to the temperature-changing apparatus, and adapted to regulate the temperature of the engine exhaust stream incident on the filter assembly based on the temperature of the exhaust stream.

2. The exhaust emission reduction system of claim 1, wherein the engine includes an exhaust manifold operatively connected to the engine and configured to channel the exhaust stream, and wherein the one or more exhaust emission reduction elements are configured to be positioned within the exhaust manifold.

3. The exhaust emissions reduction system of claim 1, wherein the engine is a turbocharged engine having a turbine driven by the exhaust stream, for powering a compressor to compress the air stream, wherein the temperature-changing apparatus is a bypass valve adapted to divert a portion of the air stream prior to combustion in the engine and wherein the diverted portion of the compressed air stream is introduced to the exhaust stream between the filter assembly and the turbine.

4. The exhaust emission reduction system of claim 1, wherein the temperature-changing apparatus includes a bypass valve adapted to divert a portion of the air stream prior to combustion in the engine and wherein the diverted portion of the air stream is introduced to the air stream upstream of the bypass valve.

5. The exhaust emission reduction system of claim 1, wherein the one or more exhaust emission reduction elements are configured to remove particulate matter, hydrocarbons, and/or carbon monoxide from the exhaust stream.

6. The exhaust emission reduction system as in claim 5, wherein the engine is a two-stroke diesel engine, wherein the one or more exhaust emission reduction elements are selected from among diesel oxidation catalysts, diesel particulate filters, and catalysed partial flow diesel particulate filters.

7. The exhaust emission reduction system as in claim 1, wherein the one or more exhaust emissions reduction elements includes a filter element, the exhaust emission reduction system further including the controller being configured for monitoring and controlling particulate buildup on the filter element.

8. The exhaust emission reduction system as in claim 7, wherein the temperature-changing apparatus includes a doser for adding fuel to the exhaust stream upstream of the exhaust emission reduction elements.

9. The exhaust emission reduction system as in claim 1, further including an exhaust gas recirculation circuit having a flow regulating device for determining a fraction of the exhaust stream to be recirculated and mixed with the air stream, and wherein the controller also is configured to control the flow regulating device.

10. The exhaust emission reduction system of claim 1, further including an exhaust after-treatment system for reducing particulate matter, hydrocarbon, carbon monoxide and/or NOₓ, the after-treatment system being configured to treat the exhaust stream at a location downstream of the filter assembly.

11. The exhaust emission reduction system as in claim 10, wherein the exhaust after-treatment system includes an after-treatment filter element, and wherein the exhaust after-treatment system also includes a thermal device operatively connected to the controller for regulating the temperature of the exhaust stream downstream of the filter assembly.

12. A method for reducing exhaust emission from an internal combustion engine, the engine receiving an air stream for combustion with fuel in the engine and generating an engine exhaust stream, and having a filter assembly having one or more exhaust emission reduction elements for processing the engine exhaust stream, a performance of at least one of the one or more exhaust emission reduction elements being temperature dependent, the method comprising;
monitoring the temperature of the exhaust stream incident on the filter assembly; and
regulating the temperature of the exhaust stream incident on the filter assembly based on the monitored temperature using a temperature-changing apparatus, and using a controller to control the temperature-changing apparatus.

13. The method as in claim 12, wherein the engine is a turbocharged engine having a turbine driven by the exhaust stream for powering a compressor to compress the air stream, wherein the regulating includes diverting a portion of the air stream prior to combustion in the engine using a bypass valve and wherein the air stream portion is diverted to the exhaust stream at a location between the filter assembly and the turbine.

14. The method as in claim 12, wherein the regulating includes diverting a portion of the air stream prior to combustion in the engine using a bypass valve, and wherein the air stream portion is diverted to the air stream that is upstream of the bypass valve.

15. The method as in claim 12, wherein the engine exhaust stream is processed by the filter assembly to remove particulate matter, hydrocarbons, and/or carbon monoxide.

16. The method as in claim 12, wherein the exhaust emission reduction elements include a filter element, and wherein the processing includes using the controller for monitoring and controlling particulate buildup on the filter element.

17. The method as in claim 12, wherein the engine further includes an exhaust gas recirculation circuit having a flow regulating device for determining a fraction of the exhaust stream to be recirculated and mixed with the air stream, and wherein the controller also controls the flow regulating device.

18. The method as in claim 12, further including reducing particulate matter, hydrocarbon, carbon monoxide and/or NOₓ in the exhaust stream at a location downstream of the emission reduction elements through the use of an after-treatment system.

19. The method as in claim 18, wherein the after-treatment system includes a filter for reducing particulate matter, hydrocarbons, and/or carbon monoxide from the exhaust stream, wherein the method further includes controlling the temperature of the exhaust stream incident on the after-treatment filter using a thermal device controlled by the controller.

20. An exhaust emission reduction system for a two-stroke diesel engine, the engine including a turbo-charger having a compressor adapted to provide a compressed air stream for combustion with fuel in the engine, and having a turbine configured for powering the compressor using an engine exhaust stream, the system comprising:
a filter assembly having one or more exhaust emission reduction elements configured to process the exhaust stream, the elements selected from among diesel oxidation catalysts, diesel particulate filters, and catalysed partial flow diesel particulate filters, a performance of at least one of the elements being temperature dependent;
an apparatus for changing the temperature of the exhaust stream incident on the filter assembly, the apparatus including a bypass valve adapted to divert a portion of the compressed air stream prior to combustion in the engine to a location in the exhaust stream downstream of the filter assembly and upstream of the turbine or to a location in the air stream upstream of the engine; and
a controller operatively connected to the bypass valve and adapted to regulate the temperature of the exhaust stream incident on the filter assembly, the controller being responsive to the temperature of the exhaust stream upstream,
wherein the engine further includes an exhaust manifold operatively connected to the engine and configured to channel the exhaust stream to the turbine and wherein the one or more exhaust emission reduction elements are positioned within the exhaust manifold.
